(19) United States
(12) Patent Application Publication
(10) Pub. No.: US 2010/0241771 A1
(43) Pub. Date: Sep. 23, 2010

(54) PERIPHERAL CIRCUIT WITH HOST LOAD ADJUSTING FUNCTION

(75) Inventors: Yasushi Nagai, Yokohama (JP); Hiroshi Nakagoe, Yokohama (JP); Shigeki Taira, Yokohama (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/668,561

(22) PCT Filed: Mar. 19, 2008
(86) PCT No.: PCT/JP2008/055118

§ 371 Date: May 19, 2010

(30) Foreign Application Priority Data
Sep. 13, 2007 (JP) 2007-237634

(51) Int. Cl. G06F 13/10; G06F 13/24; G06F 13/16

(52) U.S. Cl. 710/52; 710/260; 710/107

(57) ABSTRACT

A peripheral circuit with a host load adjusting function which is capable of readily carrying out control so that the amounts of data processed by the peripheral circuit and a host CPU are balanced by limiting interrupts made by the peripheral circuit, usage of a memory bus bandwidth, and a processing throughput of data. A typical embodiment of the present invention has an adjustment limitation setting unit setting a minimum value of an interval of interrupt requests generated by the peripheral circuit with the host load adjusting function, and a cycle counter counting generation timing of the interrupt requests, and compares a value of the cycle counter with the interval set in the adjustment limitation setting unit, thereby suppressing the interrupt requests generated at an interval shorter than the set interval.

### TECHNICAL FIELD

The present invention relates to technique for efficiently using an interrupt and a memory bus which are resources used by a peripheral circuit in a calculator system.

### BACKGROUND ART

Recently, along with development of calculator system techniques, processors are mounted in various forms in LSIs, for example, a computer system is mounted on one LSI and a CPU is mounted also on a custom LSI. Such processors have a function that sequentially executes many commands in a previously determined order and, in addition to that, have an interrupt mechanism which receives interrupt request signals and branches them to addresses different from those of the previously determined order. By virtue of the interrupt mechanism, the processors can perform flexible processing, and thus atypical processing according to programs and descriptions and realization of, for example, responses to the events which are given externally are facilitated. Note that, as technique related to the interrupt mechanism, for example, the technique of Japanese Patent Application Laid-Open Publication No. H5-143365 (Patent Document 1) is disclosed.

Patent Document 1: Japanese Patent Application Laid-Open Publication No. H5-143365

### DISCLOSURE OF THE INVENTION

### Problems to be Solved by the Invention

In many cases, the peripheral circuit which is built in a processor or externally connected to the processor has the interrupt mechanism as described above and enables flexible processing as a system. When the peripheral circuit generates an interrupt, the processor interrupts execution of a program in progress, and executes an interrupt program. Then, when the processing is finished, the processing of the interrupted program is resumed.

While flexible processing is enabled according to this working, upon switching between the main processing program and the interrupt program, the contents of a register of the processor, the contents of a memory control table and a stack, etc. have to be saved so that the processing thereof does not have inconsistency, and thus the overhead of the time for saving, etc. is generated.

The frequency of the interrupts made by the peripheral circuits is not controlled by a host CPU. Therefore, in some cases, the balance between the data amount processed by the interrupts and the data amount processed by the main processing program is disrupted, and the system performance is largely lowered. For example, if a network interface is taken as an example of the peripheral circuit, when a large amount of data larger than the amount that can be processed by a processor is received, interrupts are kept being generated before the processor completes the processing of previous data, and the state in which only interrupt programs are always being executed occurs. In this manner, since the data processing by the main processing program is not progressed while the data processing by the interrupts is progressed, the situation that the processing is not progressed as a whole system occurs.

These are the problems about the interrupt which is one of the resources provided by the processor; however, similar problems also exist about a memory bus. In recent years, along with speed-up of networks such as spread of Gbit Ethernet (trademark) and increase in the size of display screens such as spread of HD (High Definition) video processing devices, the cases in which a large amount of data is processed by peripheral circuits is increasing. In these cases, not all the processing is carried out by the peripheral circuits. Therefore, a large memory bus bandwidth is consumed since a large amount of processing results are written to the memory that is shared with the host CPU.

Also about the usage of the memory bus bandwidth, when the peripheral circuits process data more than the processing ability of the host CPU and use the memory bus bandwidth, the processing of the peripheral circuits is predominantly progressed; the processing of the data by the host CPU is not progressed; and the performance as a system is largely lowered. Therefore, the power consumption with respect to the system processing throughput becomes large, and the load applied to the environment also becomes large. Moreover, there is also a problem that the drivable time is shortened in a battery-driven system, and the value of the system is lowered. Furthermore, since the cycle of requests is not constant, the fluctuations in the system processing throughput become large, a large shared buffer is required for compensating for the difference in the fluctuations in the amounts of processing of the CPU and the peripheral circuits, and thus the system cost is increased.

Moreover, the fact that the usage of the CPU resources and the usage of the memory bus bandwidth by the interrupts of the peripheral circuits is not limited is a cause of safety deterioration of the system. For example, it leads to reception of attacks that causes abnormal operations in the control programs of the peripheral circuits by applying large load to the peripheral circuits such as network interfaces from the outside, destabilizing the operations of the main program of the system, or changing the operations.

Therefore, it is a preferred aim of the present invention to provide a peripheral circuit equipped with a host load adjusting function capable of readily carrying out control so that the amounts of the data processed by the peripheral circuit and a host CPU are balanced by limiting the interrupts made by the peripheral circuits, usage of a memory bus bandwidth, and the processing throughput of data.

The above and other preferred aims and novel characteristics of the present invention will be apparent from the description of the present specification and the accompanying drawings.

### Means for Solving the Problems

The typical ones of the inventions disclosed in the present application will be briefly described as follows.

A peripheral circuit equipped with a host load adjusting function according to a typical embodiment of the present invention has a feature of having: a setting unit which sets a minimum value of an interval of interrupts and a memory bus usage request generated by the peripheral circuit; and a counter which counts a generation timing of the interrupt and the memory bus usage request, wherein the interrupt generated at an interval shorter than the set interval is suppressed by comparing the counter value and the interval set in the setting unit.

### EFFECTS OF THE INVENTION

The effects obtained by typical aspects of the present invention will be briefly described below.

According to the typical embodiment of the present invention, the interrupt request and memory bus usage request at the interval shorter than that set in the setting unit can be blocked by the peripheral circuit in terms of hardware and prevented from being uploaded to a CPU, and the requests exceeding an processing ability of the CPU are prevented from being uploaded from the peripheral circuit; therefore, stability as a system is improved, and control can be carried out so that amounts of data processed by the peripheral circuit and the host CPU can be balanced.

### BRIEF DESCRIPTIONS OF THE DRAWINGS

FIG. 1 is a functional block diagram illustrating a configuration of an information processing device having a peripheral circuit equipped with a host load adjusting function which is a first embodiment of the present invention;

FIG. 2 is a diagram illustrating setting items of an adjustment limitation setting unit of the first embodiment of the present invention;

FIG. 3 is a flow chart illustrating operations of a request generation interval adjusting unit of the first embodiment of the present invention; and

FIG. 4 is a functional block diagram illustrating a configuration of an information processing device having a peripheral circuit equipped with a host load adjusting function which is a second embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

A peripheral circuit equipped with a host load adjusting function which is an embodiment of the present invention has a register which sets a minimum value of intervals of generated requests of interrupt and memory bus usage and a counter which counts generation timings of the requests of the interrupt and memory bus usage, wherein the value of the counter and the interval set in the register are compared with each other, thereby suppressing the interrupt requests that are generated at an interval shorter than the set time period. As a result, the processing throughput of main processing programs and the processing throughput of the peripheral circuit can be set so as to be balanced, and high system performance can be readily realized.

### First Embodiment

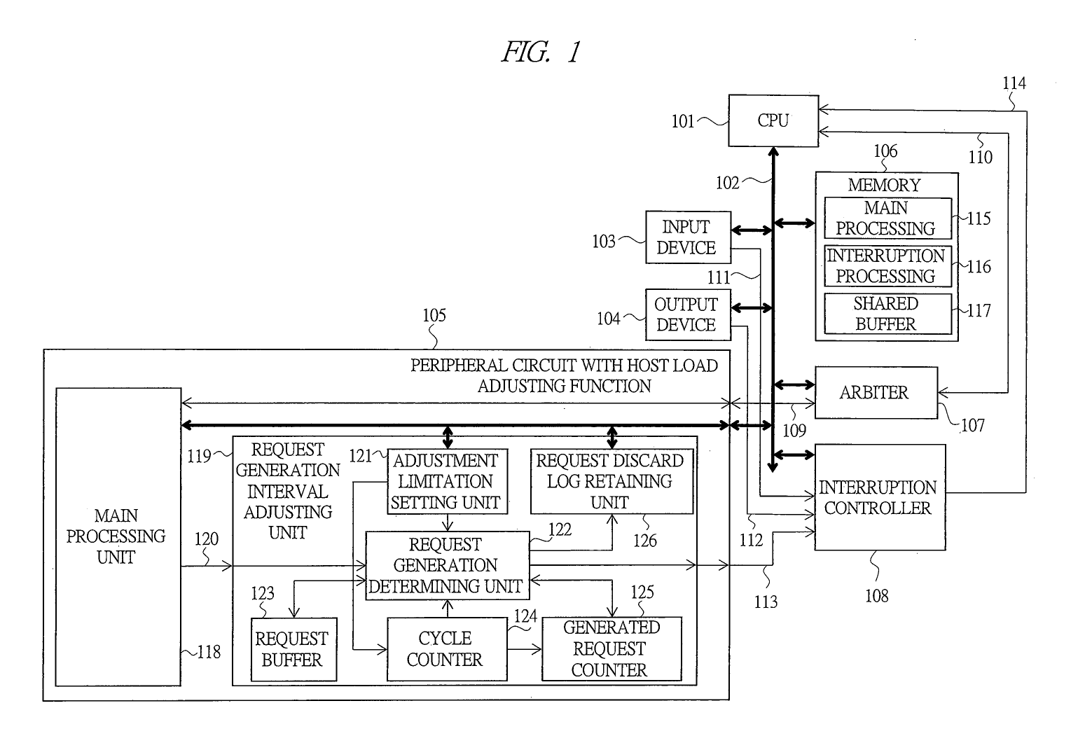

A peripheral circuit equipped with a host load adjusting function which is a first embodiment of the present invention will be described with reference to FIG. 1 to FIG. 3. FIG. 1 is a functional block diagram illustrating a configuration of an information processing device having the peripheral circuit equipped with the host load adjusting function of the present embodiment.

In the information processing device illustrated in FIG. 1, via a bus 102, a CPU 101 carries out management and control of various devices, i.e., an input device 103, an output device 104, a peripheral circuit 105 equipped with a host load adjusting function (hereinafter, it will be described as “peripheral circuit 105”), a memory 106, an arbiter 107, and an interrupt controller 108. The input device 103 receives user operations and input data with respect to the information processing device using the peripheral circuit 105 of the present embodiment. The output device 104 transmits notification information and data to a user from the information processing device using the peripheral circuit 105 of the present embodiment.

The contents of the peripheral circuit 105 will be described later. The memory 106 stores programs and data to be executed by the CPU 101. The arbiter 107 arbitrates bus usage requests from the CPU 101 and the peripheral circuit 105. The interrupt controller 108 arbitrates interrupt requests from the input device 103, the output device 104, and the peripheral circuit 105 to the CPU 101.

The arbiter 107 receives the bus usage requests from the CPU 101 and the peripheral circuit 105 via bus usage requests and permissions 109 and 110. The bus usage request and permission 109 are the information about a bus usage request from the peripheral circuit 105 and a bus usage permission for the bus usage request. The arbiter 107 receives the bus usage requests from the peripheral circuit 105 via the bus usage request 109, and, as a result of arbitration, returns a notification about whether the peripheral circuit 105 can use the bus 102 or not via the bus usage permission 109.

Similarly, the bus usage request and permission 110 is the information about a bus usage request from the CPU 101 and the bus usage permissions for the bus usage requests. The arbiter 107 receives the bus usage request from the CPU 101 via the bus usage request 110 and, as a result of arbitration, returns a notification about whether the CPU 101 can use the bus 102 or not via the bus usage permission 110.

The interrupt controller 108 receives interrupt requests from the input device 103, the output device 104, and the peripheral circuit 105 to the CPU 101 via interrupt requests 111, 112, and 113, arbitrates them in accordance with a set order of priority via the bus 102, and uploads the interrupt requests to the CPU 101 via interrupt requests 114. Herein, the interrupt request 111 is an interrupt request from the input device 103, the interrupt request 112 is an interrupt request from the output device 104, and the interrupt request 113 is an interrupt request from the peripheral circuit 105.

In the state in which no interrupt is generated, the CPU 101 is executing a main processing program 115 stored in the memory 106. When the interrupt requests are received in this state via the interrupt requests 114, a register, stack, etc. of the CPU 101, which is in the executing state of the main processing program 115 in progress, are saved, execution of an interrupt processing program 116 is started, and processing is carried out in accordance with the state of the input device 103, the output device 104, and the peripheral circuit 105 which are the request sources.

When a small amount of data is to be transmitted between these devices, the transmission is carried out by read/write of registers and built-in memories of the input device 103, the output device 104, and the peripheral circuit 105; however, when a large amount of data is to be handled, a shared buffer 117 reserved in the memory 106 is shared among the input device 103, the output device 104, the peripheral circuit 105, and the CPU 101, so as to perform processing of the data. When processing of the interrupt processing program 116 is finished, the register, stack, etc. are returned to the saved execution state of the main processing program 115, and execution of the main processing program 115 is resumed.

The peripheral circuit 105 of the present embodiment is composed of a main processing unit 118 which performs main processing such as cryptographic processing, DMA transfers, image processing, internal processing accelerators, network processing, and storage inputs/outputs, and a request generation interval adjusting unit 119 which adjusts the generation timing of the interrupt request 113 related to an interrupt request factor 120 generated by the main processing unit 118.

The request generation interval adjusting unit 119 is composed of an adjustment limitation setting unit 121, a request generation determining unit 122, a request buffer 123, a cycle counter 124, a generated request counter 125, and a request discarding log retaining unit 126. The adjustment limitation setting unit 121 sets limitation information about the request generated by the peripheral circuit 105 of the present embodiment. In accordance with the limitation information set in the adjustment limitation setting unit 121, the request generation determining unit 122 determines whether to generate the interrupt request factor 120, which is generated by the main processing unit 118, as the interrupt request 113 or not.

The request buffer 123 temporarily saves the interrupt request factor 120 generated by the main processing unit 118, readjusts the interval to the interval set by the adjustment limitation setting unit 121, and uses the interval for generating the interrupt requests 113. The cycle counter 124 counts generation timing of the interrupt request 113. The generation request counter 125 measures the number of times of generation of the generated interrupt requests 113 per a certain period of time and the amount of consumption of resources such as bus bandwidths related to the requests. The request discarding log retaining unit 126 retains the generation status and statistical information of the interrupt request factors 120, which are discarded by the request generation determining unit 122 because of too many interrupt request factors 120 generated by the main processing unit 118, in order to inform the CPU 101 of the status and information.

The adjustment limitation setting unit 121 provides means of setting the limitation information about generation of the interrupt request 113 by the CPU 101 via the bus 102. The method of setting the limitation information by the adjustment limitation setting unit 121 is provided in the form of a register or a descriptor.

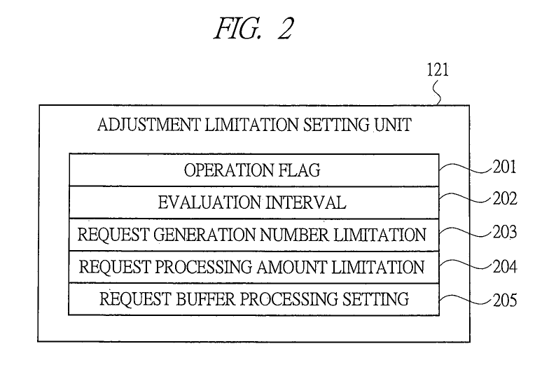

FIG. 2 is a diagram illustrating setting items of the adjustment limitation setting unit 121 of the present embodiment. The setting items are an operation flag 201, an evaluation interval 202, a limitation on the number of request generation 203, a limitation on the request processing amount 204, and a request buffer processing setting 205. Herein, limitation on request processing amount 204 is the limitation about the CPU usage time of interrupts and the amount of usage of system resources such as bus bandwidths; and the limitation enables evaluation in which the requests are weighted depending on the types or the like of interrupts, upon processing related to the requests generated by the peripheral circuit 105.

The request buffer processing setting 205 sets a priority order of the processing of the interrupt request factors 120, which are temporarily saved in the request buffer 123, and the processing contents of the case in which the request buffer 123 is overflowed. The processing contents that can be set are the following six types.

(1) The newer interrupt request factors 120 are prioritized; and, when the request buffer 123 is overflowed, the main processing unit 118 is caused to be stand-by.
(2) The newer interrupt request factors 120 are prioritized; and, when the request buffer 123 is overflowed, the interrupt request factors 120 of lower priority order are discarded, and the operation is continued.
(3) The newer interrupt request factors 120 are prioritized; and, when the request buffer 123 is overflowed, the interrupt request factors 120 of lower priority order are discarded, and the operation is finished.
(4) The older interrupt request factors 120 are prioritized; and, when the request buffer 123 is overflowed, the main processing unit 118 is caused to be stand-by.
(5) The older interrupt request factors 120 are prioritized; and, when the request buffer 123 is overflowed, the interrupt request factors 120 of lower priority order are discarded, and the operation is continued.
(6) The older interrupt request factors 120 are prioritized; and, when the request buffer 123 is overflowed, the interrupt request factors 120 of lower priority order are discarded, and the operation is finished.

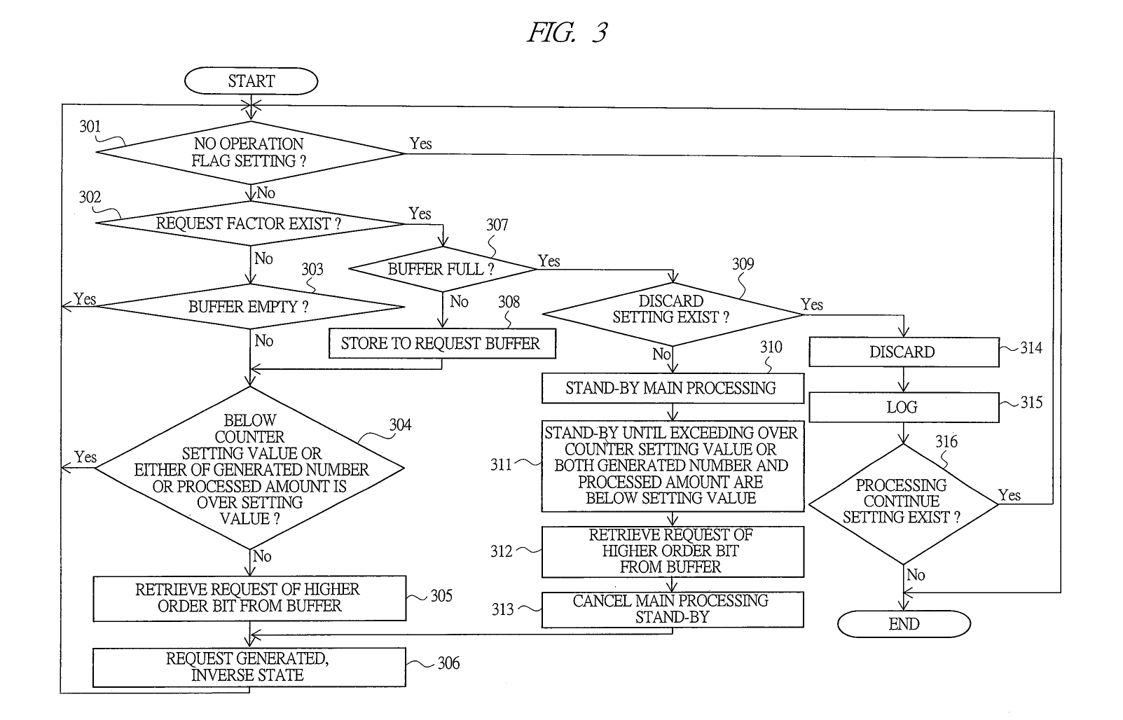

The request generation interval adjusting unit 119 composed of the above-described units operates following the flow chart illustrated in FIG. 3. First, in a step 301, the request generation determining unit 122 evaluates the state of the operation flag 201, which is provided by the adjustment limitation setting unit 121. As a result, if the operation flag is not set, the process is finished; and, if the operation flag is set, the process proceeds to a step 302. In the step 302, the request generation determining unit 122 evaluates the presence of the interrupt request factors 120, which are from the main processing unit 118. If the interrupt request factors 120 are present, the process proceeds to a step 307; and, if they are not present, the process proceeds to a step 303.

In the step 303, the request generation determining unit 122 checks the state of the request buffer 123. According to a result, if the request buffer 123 is empty, the process returns to the step 301 since there is no interrupt request factor 120 which can be processed. If the request buffer 123 is not empty, the process proceeds to a step 304 since the interrupt request factors 120 to be processed are present.

In the step 304, the request generation determining unit 122 compares the cycle counter 124 with the evaluation interval 202 and compares the generation request counter 125 with the limitation on the number of request generation 203 or the limitation on request processing amount 204. As a result, if the cycle counter 124 is less than the evaluation interval 202, or, if either the number of times of generation or the processing amount of the requests at the generated request counter 125 is more than or equal to the limitation on the number of times of request generation 203 or the limitation on request processing amount 204, it is determined that this is not the timing for generating the interrupt request 113, and the process returns to the step 301 for ensuring an interval.

If the above-described condition is not satisfied, the interrupt request factor 120 of the highest priority order is retrieved from the request buffer 123 in accordance with the priority order set in the request buffer processing setting 205 in a step 305 in order to generate the interrupt request 113, and the process proceeds to a step 306 to generate the interrupt request 113.

In a step 307, the request generation determining unit 122 checks whether the request buffer 123 is in a full state or not. If the buffer is not in the full state, the process proceeds to a step 308 to store the interrupt request factors 120 in the request buffer 123, so that the state in which the interrupt requests 113 about the interrupt request factors 120 can be generated is achieved. If the request buffer 123 is in the full state, since the new interrupt request factors 120 cannot be stored, the process proceeds to a step 309 to process the overflowed interrupt request factors 120.

In the step 309, whether to discard the overflowed interrupt request factors 120 or not is determined in accordance with the setting of the request buffer processing setting 205. When they are to be discarded, the process proceeds to a step 314 to discard the interrupt request factors 120 of low priority order. If they are not to be discarded, the process proceeds to a step 310 to cause the main processing unit 118 to be in a stand-by state so that no more interrupt request factors 120 are generated. Then, in a step 311, the process is on stand-by for the overflowed interrupt request factors 120 from the main processing unit 118 and the interrupt request factors 120 stored in the request buffer 123 to be processable.

In the step 311, when the interrupt request factors 120 become processable, the process proceeds to a step 312 to retrieve the interrupt request factor 120 of the highest priority order among the overflowed interrupt request factors 120 from the main processing unit 118 and the interrupt request factors 120 stored in the request buffer 123, and the process proceeds to a step 313. In the step 313, the stand-by state of the main processing unit 118 is cancelled, and the process proceeds to a step 306. In the step 306, the request generation determining unit 122 generates the interrupt request 113 about the retrieved interrupt request factor 120.

In the step 314, the interrupt request factor 120 of the lowest priority order among the overflowed interrupt request factors 120 from the main processing unit 118 and the interrupt request factors 120 stored in the request buffer 123 are retrieved and discarded, and the process proceeds to a step 315. In the step 315, the statistical information of the discarded interrupt request factors 120 is recorded in the request discarding log retaining unit 126, the contents thereof are transmitted to the CPU 101, and the process proceeds to a step 316. In the step 316, if the process is to be continued following the setting of the request buffer processing setting 205, the process returns to the step 301. If the process is not to be continued, the process is finished.

As described above, control can be carried out so as to process a constant amount at a constant interval by using the request buffer 123 and lengthening the part in which the generation interval is short and shortening the part in which the interval is long regarding the interrupt request factors 120.

Thus, even when the processing ability of the CPU 101 is changed, for example, in order to reduce the cost, lower the clock frequency of the CPU 101 for lowering the power consumption, or increase the clock frequency of the CPU 101 for improving performance, the processing abilities of the CPU 101 and the peripheral processing device can be balanced by the processing throughput determination function of, e.g., the interrupt interval in the peripheral circuit 105, and the state in which the best performance can be exerted as a system can be readily achieved. Furthermore, by enhancing the usage efficiency of the system, the power consumption can be lowered by lowering the operation clock frequency of the system, and long-time drive can be achieved in a battery-driven system.

Moreover, fluctuations in the data processing amount can be reduced as a result, the capacity of the shared buffer 117 can be reduced, and the system cost can be also reduced. Moreover, for example, also in the case of a multi-processor configuration, when the main processing unit 118 is configured as a processor, the balance of resources such as interrupts and memory bus bandwidths can be adjusted between the CPU 101 and the processor of the main processing unit 118, so that the system performance thereof can be improved.

Note that, in the case in which simple control is to be carried out, the request buffer 123 may be eliminated from the configuration. In this case, the size of the request buffer 123 is supposed to be 0, and processing can be carried out on the assumption that the request buffer 123 is always in the full state.

### Second Embodiment

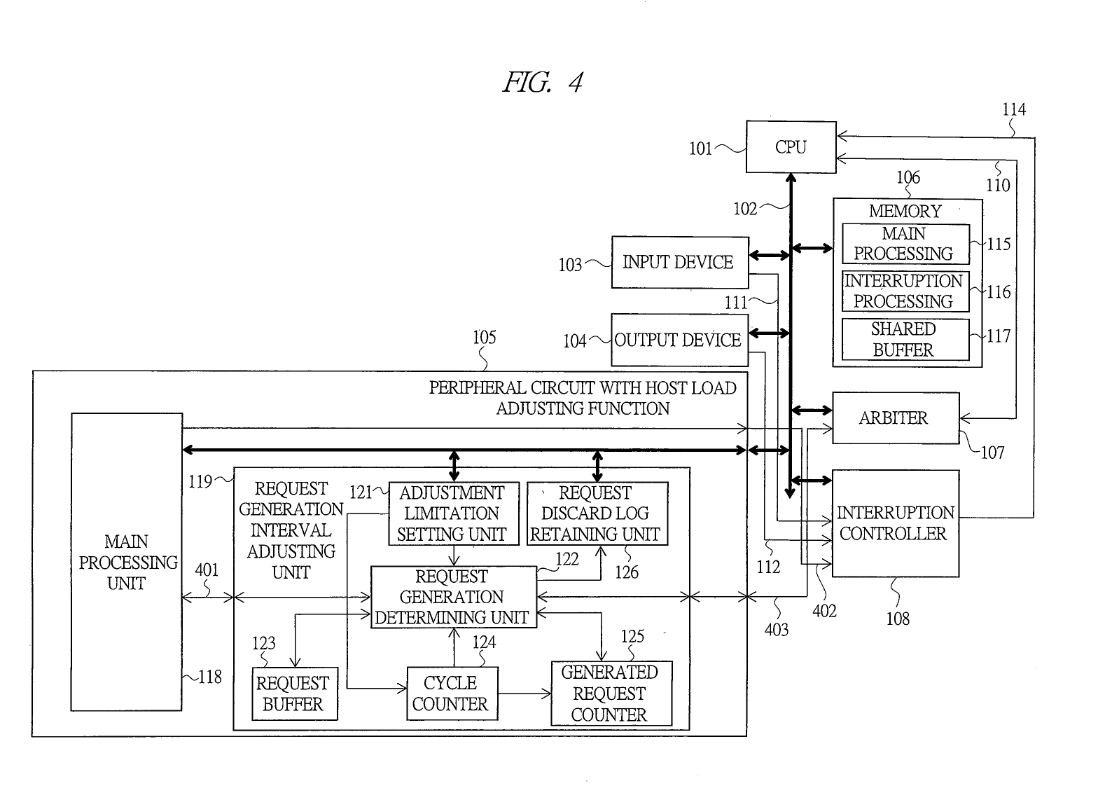

A peripheral circuit equipped with a host load adjusting function which is a second embodiment of the present invention will be described with reference to FIG. 4. FIG. 4 is a functional block diagram illustrating a configuration of an information processing device having the peripheral circuit equipped with the host load adjusting function of the present embodiment.

In the present embodiment, request factors processed by the request generation interval adjusting unit 119 are bus usage request factors 401 which are requests to use the bus 102. Even when they are not the requests for interrupt to the CPU 101, but the bus usage request factors 401 as described above, as same as the first embodiment, the usage of the bus bandwidth can be limited by carrying out an operation following the flow chart illustrated in FIG. 3. As a result, the usage rate of the memory bus bandwidth can be limited, and the memory bus can be used at an optimal rate by the CPU 101 and the peripheral circuit 105, thereby improving the system performance.

Note that, in the request generation interval adjusting unit 119, both the limitation of the first embodiment on the interrupt requests and the limitation of the present embodiment on the bus usage requests can be carried out.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The peripheral circuit equipped with the host load adjusting function of the present invention can be used in devices of high-speed network interfaces, network processing accelerators, etc. such as decoders, tuners, data processing, DMA controllers, cryptographic processing accelerators, storage interfaces, Gbit Ethernet (trademark) interfaces, which generate many interrupts for processing a large amount of data and consume a memory bus bandwidth.

1. A peripheral circuit with a host load adjusting function, the peripheral circuit generating requests for processing by interrupt with respect to a CPU and requests for a memory bus usage right, and the peripheral circuit comprising:
a main processing unit generating request factors; and a request generation interval adjusting unit generating the requests related to the request factors generated by the main processing unit with adjusting generation timing, wherein
the request generation interval adjusting unit has:
a cycle counter counting the generation timing of the requests; and an adjustment limitation setting unit setting a generation interval of the requests, and
the generation timing of the requests is adjusted by generating the requests related to the request factors generated by the main processing unit in the form of interrupt requests or memory bus usage right requests at an interval more than or longer than the generation interval set in the adjustment limitation setting unit.

2. The peripheral circuit with a host load adjusting function according to claim 1, wherein
the request generation interval adjusting unit has a generation request counter which measures the number of times of generation of the requests per a certain period of time and an amount of consumption of a resource related to the requests;
limitation information about the number of times of generation of the requests per the certain period of time and the amount of consumption of the resource related to the requests can be set in the adjustment limitation setting unit; and,
only when a value measured by the generation request counter is smaller than a value of the limitation information set in the adjustment limitation setting unit, the generation timing of the requests is adjusted by generating the requests related to the request factors generated by the main processing unit in the form of the interrupt requests or the memory bus usage right requests.

3. The peripheral circuit with a host load adjusting function according to claim 1, wherein
the request generation interval adjusting unit adjusts the generation timing of the requests by discarding the request factor generated by the main processing unit at an interval shorter than the generation interval of the requests set in the adjustment limitation setting unit, and not generating the request related to the request factor.

4. The peripheral circuit with a host load adjusting function according to claim 2, wherein
the request generation interval adjusting unit adjusts the generation timing of the requests by discarding the request factor generated by the main processing unit at an interval shorter than the generation interval of the requests set in the adjustment limitation setting unit, and not generating the request related to the request factor.

5. The peripheral circuit with a host load adjusting function according to claim 1, wherein
the request generation interval adjusting unit adjusts the generation timing of the requests by delaying generation of the request related to the request factor generated by the main processing unit at an interval shorter than the generation interval of the requests set in the adjustment limitation setting unit until an interval longer than or equal to the generation interval of the requests set in the adjustment limitation setting unit is ensured, and, during this period, processing in the main processing unit is in stand-by.

6. The peripheral circuit with a host load adjusting function according to claim 2, wherein
the request generation interval adjusting unit adjusts the generation timing of the requests by delaying generation of the request related to the request factor generated by the main processing unit at an interval shorter than the generation interval of the requests set in the adjustment limitation setting unit until an interval longer than or equal to the generation interval of the requests set in the adjustment limitation setting unit is ensured, and, during this period, processing in the main processing unit is in stand-by.

7. The peripheral circuit with a host load adjusting function according to claim 1, wherein
the request generation interval adjusting unit has a request buffer which temporarily saves the request factors generated by the main processing unit, and adjusts the generation timing of the requests by generating the request related to the request factor temporarily saved in the request buffer at the generation interval of the requests set in the adjustment limitation setting unit.

8. The peripheral circuit with a host load adjusting function according to claim 2, wherein
the request generation interval adjusting unit has a request buffer which temporarily saves the request factors generated by the main processing unit, and adjusts the generation timing of the requests by generating the request related to the request factor temporarily saved in the request buffer at the generation interval of the requests set in the adjustment limitation setting unit.

9. The peripheral circuit with a host load adjusting function according to claim 7, wherein,
if not all of the request factors generated by the main processing unit cannot be temporarily saved in the request buffer,
the request generation interval adjusting unit discards the request factor generated by the main processing unit or the request factor temporarily saved in the request buffer.

10. The peripheral circuit with a host load adjusting function according to claim 8, wherein,
if not all of the request factors generated by the main processing unit cannot be temporarily saved in the request buffer,
the request generation interval adjusting unit discards the request factor generated by the main processing unit or the request factor temporarily saved in the request buffer.

11. The peripheral circuit equipped with a host load adjusting function according to claim 7, wherein
if not all of the request factors generated by the main processing unit cannot be temporarily saved in the request buffer,
the request generation interval adjusting unit causes processing in the main processing unit to be in stand-by until the request factor generated by the main processing unit or the request factor temporarily saved in the request buffer is processed at the generation interval of the requests set in the adjustment limitation setting unit.

12. The peripheral circuit equipped with a host load adjusting function according to claim 8, wherein
if not all of the request factors generated by the main processing unit cannot be temporarily saved in the request buffer,
the request generation interval adjusting unit causes processing in the main processing unit to be in stand-by until the request factor generated by the main processing unit or the request factor temporarily saved in the request buffer is processed at the generation interval of the requests set in the adjustment limitation setting unit.

13. The peripheral circuit equipped with a host load adjusting function according to claim 7, wherein,
upon generating the request related to the request factor generated by the main processing unit or the request factor temporarily saved in the request buffer or upon discarding the request factor,
the request generation interval adjusting unit carries out processing based on a priority order of the request factors.

14. The peripheral circuit equipped with a host load adjusting function according to claim 8, wherein,
upon generating the request related to the request factor generated by the main processing unit or the request factor temporarily saved in the request buffer or upon discarding the request factor,
the request generation interval adjusting unit carries out processing based on a priority order of the request factors.

15. The peripheral circuit equipped with a host load adjusting function according to claim 9, wherein
upon generating the request related to the request factor generated by the main processing unit or the request factor temporarily saved in the request buffer or upon discarding the request factor,
the request generation interval adjusting unit carries out processing based on a priority order of the request factors.

16. The peripheral circuit equipped with a host load adjusting function according to claim 10, wherein
upon generating the request related to the request factor generated by the main processing unit or the request factor temporarily saved in the request buffer or upon discarding the request factor,
the request generation interval adjusting unit carries out processing based on a priority order of the request factors.

17. The peripheral circuit equipped with a host load adjusting function according to claim 11, wherein
upon generating the request related to the request factor generated by the main processing unit or the request factor temporarily saved in the request buffer or upon discarding the request factor,
the request generation interval adjusting unit carries out processing based on a priority order of the request factors.

18. The peripheral circuit equipped with a host load adjusting function according to claim 12, wherein
upon generating the request related to the request factor generated by the main processing unit or the request factor temporarily saved in the request buffer or upon discarding the request factor,
the request generation interval adjusting unit carries out processing based on a priority order of the request factors.

19. The peripheral circuit with a host load adjusting function according to claim 1, wherein
the request generation interval adjusting unit has: a request buffer temporarily saving the request factors generated in the main processing unit; and a generated request counter measuring the number of times of generation of the requests per a certain period of time and an amount of consumption of a resource related to the requests;
limitation information about the number of times of generation of the requests per the certain period of time and the amount of consumption of the resource related to the requests can be set in the adjustment limitation setting unit, and,
if the request buffer has an empty space,
the request factors temporarily saved in the request buffer are retrieved following a priority order of the request factors set in the adjustment limitation setting unit to generate the request related to the request factor if a value of the cycle counter is larger than or equal to the generation interval of the requests set in the adjustment limitation setting unit, and the number of times of generation of the requests measured by the generated request counter is below the number of times of generation of the requests set in the adjustment limitation setting unit, and an amount of consumption of the resource measured in the generated request counter is below an amount of consumption of the resource set in the adjustment limitation setting unit; and
the request is not generated if the value of the cycle counter is below the generation interval of the requests set in the adjustment limitation setting unit, or, the number of times of generation of the requests measured in the generated request counter is larger than or equal to the number of times of generation of the requests set in the adjustment limitation setting unit, or, the amount of consumption of the resource measured in the generated request counter is larger than or equal to the amount of consumption of the resource set in the adjustment limitation setting unit, and,
if the request buffer overflows,
the request factors which cannot be temporarily saved in the request buffer are discarded following the priority order of the request factors set in the adjustment limitation setting unit and statistic information about the discarded request factors is recorded in a log and notified to the CPU; or processing in the main processing unit is caused to be in stand-by until the request factors generated in the main processing unit or the request factors temporarily saved in the buffer become processable.

20. The peripheral circuit with a host load adjusting function according to claim 1, wherein
the request generation interval adjusting unit has a request buffer temporarily saving the request factors generated in the main processing unit,
processing contents of the request generation interval setting unit for the case of an overflow of the request buffer can be set in the adjustment limitation setting unit, and,
if the buffer overflows, the request related to the request factor is processed following the processing contents set in the adjustment limitation setting unit.
